(19) United States
(12) Patent Application Publication
(10) Pub. No.: US 2013/0180225 A1
(43) Pub. Date: Jul. 18, 2013

(54) BEARING THERMOMETER SYSTEM FOR A PIECE OF EQUIPMENT

(71) Applicants: Mikhail Dexter, Amelia, NE (US); Darla Dexter, Amelia, NE (US); Ron Dexter, Amelia, NE (US)

(72) Inventors: Mikhail Dexter, Amelia, NE (US); Darla Dexter, Amelia, NE (US); Ron Dexter, Amelia, NE (US)

(21) Appl. No.: 13/350,750

(22) Filed: Jan. 14, 2012

(51) Int. Cl. A01D 75/00; A01F 15/08; G01K 7/00; A01D 41/127

(52) U.S. Cl. 56/10.2 R; 374/170; 374/E07.001

(57) ABSTRACT

The present invention is a bearing thermometer system that includes a plurality of temperature displays that provide a digital indication of a current temperature reading of one or more bearings associated with a piece of bearing related equipment that is typically agricultural equipment. The bearing thermometer system also includes a plurality of digital thermometers that digitally indicate on the temperature display the current temperature of the one or more bearings and a plurality of wire leads that are secured to the one or more bearings and the digital thermometers and the temperature displays wire leads that place the one or more bearings in communication with the digital thermometers and the temperature displays.

### TECHNICAL FIELD & BACKGROUND

If one part of a piece of mechanical equipment malfunctions such as on a hay baler or a combine, the mechanical equipment may heat up presenting a fire hazard. It can be expensive to replace components of a machine and be very dangerous due to such damage.

The present invention generally relates to a thermometer system. More specifically, the invention is a bearing thermometer system.

It is an object of the invention to provide a bearing thermometer system that indicates a plurality of temperature readings of a plurality of bearings on a piece of bearing related equipment that includes agricultural equipment such as a hay baler or a combine.

It is an object of the invention to provide a bearing thermometer system that allows a user to monitor a plurality of temperature readings of a plurality of bearings to prevent fire or heat damage to a piece of bearing related equipment.

It is an object of the invention to provide a bearing thermometer system that utilizes a plurality of digital thermometer displays that allows a user to monitor a plurality of temperature readings of a plurality of bearings to prevent fire or heat damage to a piece of agricultural equipment.

What is really needed is a bearing thermometer system that indicates a plurality of temperature readings of a plurality of bearings on a piece of equipment such as a hay baler or a combine that allows a user to monitor a plurality of temperature readings of a plurality of bearings to prevent fire or heat damage to a piece of equipment such as agricultural equipment that utilizes a plurality of digital thermometer displays that allows a user to monitor a plurality of temperature readings of a plurality of bearings to prevent fire or heat damage to a piece of equipment.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a block diagram of a bearing thermometer system, in accordance with one embodiment of the present invention.

FIG. 1B illustrates a front view of a bearing thermometer system, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

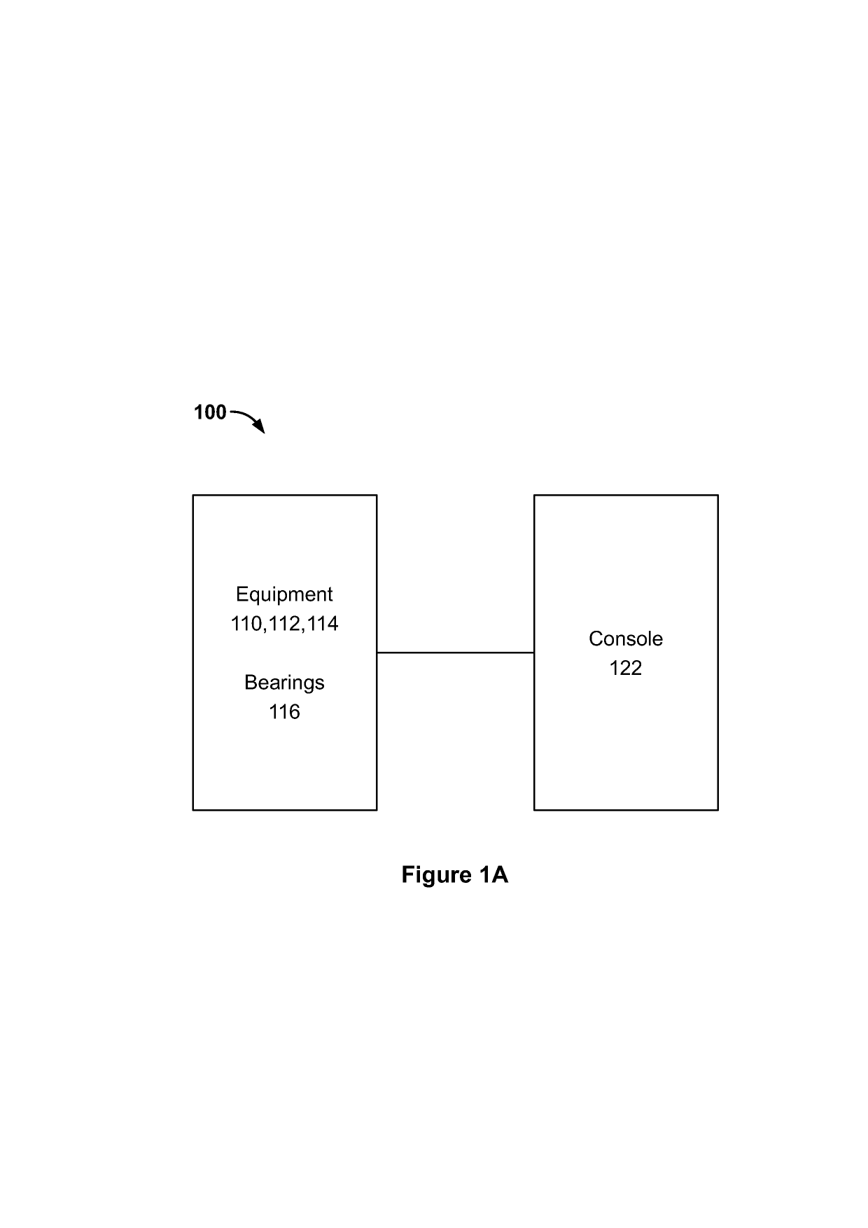

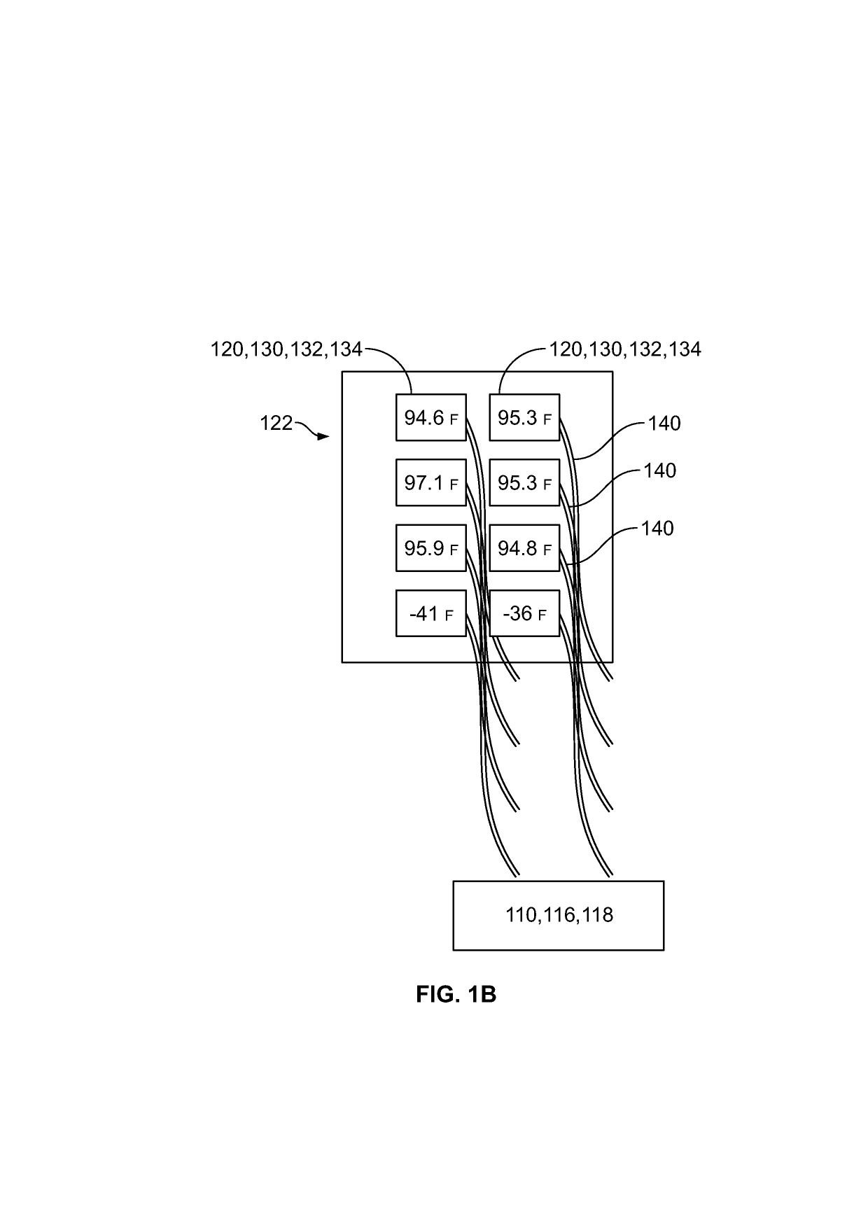

FIG. 1A illustrates a block diagram of a bearing thermometer system 100, in accordance with one embodiment of the present invention.

The bearing thermometer system 100 is typically utilized by a piece of agricultural equipment 110 such as a hay baler 112 or a combine 114 or other suitable piece of equipment that is in communication with a console 122 of the bearing thermometer system 100 to monitor the temperature of the bearings 116 associated and utilized with the piece of equipment 110, however the agricultural equipment can be any suitable bearing-related piece of equipment which can be agricultural or non-agricultural equipment.

FIG. 1B illustrates a front view of a bearing thermometer system 100, in accordance with one embodiment of the present invention.

The bearing thermometer system 100 includes a plurality of temperature displays 120, a plurality of digital thermometers 130 and a plurality of wire leads 140. The temperature displays 120 provide a digital indication of the current temperature reading of the one or more bearings 116. The plurality of temperature displays 120 is disposed on a main console 122 that is typically placed in the piece of agricultural equipment 110 in communication with a central location 118 on the piece of agricultural equipment 110 or other suitable type of equipment being protected by the bearing thermometer system 100. The digital thermometers 130 indicate digitally the current temperature readings with the temperature display 120 what the current temperature of the one or more bearings 116 is with each individual digital thermometer 130 being in communication with each individual one or more bearings 116. The temperature display 120 can be in Celsius degrees or Fahrenheit degrees and can be an LED digital display 134 or other suitable digital display. The wire leads 140 are secured to the one or more bearings 116 and place the one or more bearings 116 in communication with the digital thermometers 130 and temperature display 132.

The bearing thermometer system indicates a plurality of temperature readings of a plurality of bearings on a piece of equipment that includes agricultural equipment such as a hay baler or a combine that allows a user to monitor a plurality of temperature readings of a plurality of bearings to prevent fire or heat damage to a piece of agricultural equipment that utilizes a plurality of digital thermometer displays that allows a user to monitor a plurality of temperature readings of a plurality of bearings to prevent fire or heat damage to a piece of agricultural equipment.

The bearing thermometer system maintains the temperature readings of the bearing-related moving parts in hay balers, combines and other suitable bearing-related moving parts. Comprised of a plurality of 2″×3″ digital temperature displays, the bearing thermometer system allows the user to monitor bearing related machinery and intervene if a part becomes overheated. The main console is placed in the operator's station with a plurality of wires leading to a central location on the equipment to permit monitoring of the bearings of the component.

Farmers and ranchers are typically the users who may find the bearing thermometer system most useful that is both relatively convenient and easy to use. The bearing thermometer system features a digital display to allow the user to monitor the temperature of the bearings related to the agriculture equipment. The bearing thermometer system is designed to protect other parts of equipment from overheating as well.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A bearing thermometer system, comprising:
a plurality of temperature displays that provide a digital indication of a current temperature reading of one or more bearings associated with a piece of bearing related equipment;
a plurality of digital thermometers that digitally indicate on said temperature display said current temperature of said one or more bearings; and
a plurality of wire leads that are secured to said one or more bearings and said digital thermometers and said temperature displays.

2. The system according to claim 1, wherein said temperature displays are disposed on a main console on said piece of equipment.

3. The system according to claim 1, wherein said temperature displays are placed in an operator's station of said piece of equipment.

4. The system according to claim 1, wherein said temperature displays are in Celsius degrees or Fahrenheit degrees.

5. The system according to claim 1, wherein said temperature displays are an LED display.

6. The system according to claim 1, wherein said wire leads place said one or more bearings in communication with said digital thermometers and said temperature displays.

7. The system according to claim 1, wherein said bearing thermometer system is in communication with said piece of bearing related equipment to monitor said current temperature readings of said one or more bearings associated and utilized with said piece of bearing related equipment.

8. The system according to claim 1, wherein said equipment is a piece of agricultural equipment.

9. The system according to claim 8, wherein said equipment is a hay baler.

10. The system according to claim 8, wherein said equipment is a combine.

11. A bearing thermometer system, comprising:
a plurality of LED temperature displays that provide a digital indication of a current temperature reading of one or more bearings associated with a piece of agricultural bearing related equipment;
a plurality of digital thermometers that digitally indicate on said temperature display said current temperature of said one or more bearings; and
a plurality of wire leads that are secured to said one or more bearings and said digital thermometers and said temperature displays.

12. The system according to claim 11, wherein said temperature displays are disposed on a main console on said piece of equipment.

13. The system according to claim 11, wherein said temperature displays are placed in an operator's station of said piece of equipment.

14. The system according to claim 11, wherein said temperature displays are in Celsius degrees or Fahrenheit degrees.

15. The system according to claim 11, wherein said digital temperature displays are approximately 3 inches wide and 2 inches in height.

16. The system according to claim 11, wherein said wire leads place said one or more bearings in communication with said digital thermometers and said temperature displays.

17. The system according to claim 11, wherein said bearing thermometer system is in communication with said piece of bearing related equipment to monitor said current temperature readings of said one or more bearings associated and utilized with said piece of bearing related equipment.

18. The system according to claim 17, wherein said agricultural equipment is a hay baler.

19. The system according to claim 17, wherein said agricultural equipment is a combine.

20. The system according to claim 11, wherein said bearing thermometer system allows a user to monitor said bearing related machinery and intervenes if a part of said bearing related machinery becomes overheated.
